(19) United States
(12) Patent Application Publication
(10) Pub. No.: US 2021/0283963 A1
(43) Pub. Date: Sep. 16, 2021

(54) TRAILER-MOUNTABLE SUPPORT ASSEMBLY FOR TRAILER COLLAPSE PREVENTION

(71) Applicant: Ideal Warehouse Innovations, Inc., Vaughan (CA)

(72) Inventor: Joseph J. DI BIASE, Vaughan (CA)

(21) Appl. No.: 17/201,836

(22) Filed: Mar. 15, 2021

Related U.S. Application Data
(60) Provisional application No. 62/989,300, filed on Mar. 13, 2020.

(51) Int. Cl. B60D 1/66

(52) U.S. Cl. CPC B60D 1/66

(57) ABSTRACT

The present invention relates to a trailer-mountable retractable support assembly for supporting a freestanding trailer having a landing gear. The support assembly comprises a mounting assembly for mounting the support assembly to the underside of a trailer. The support assembly also comprises a frame assembly moveably connected to the mounting assembly, wherein the frame assembly is moveable between a stored position wherein the frame assembly is retracted away from the vertical towards the underside of the trailer and a supporting position wherein the frame assembly is substantially vertical and is capable of supporting and stabilizing the trailer on a ground surface when the landing gear fails.

### FIELD OF THE INVENTION

The present invention relates to auxiliary support assemblies for supporting the trailers of semi-tractor-trailer trucks parked at loading docks and more particularly to trailer-mountable auxiliary support assemblies comprising one or more moveable support members extendable towards the ground surface and capable of supporting the trailer and retractable towards the underside of the trailer for storage when not in use.

### BACKGROUND OF THE INVENTION

A semi-tractor-trailer truck is the combination of a tractor unit and one, or more, semi-trailers to carry freight, wherein the semi-trailer attaches to the tractor unit with a type of hitch called a fifth-wheel. A semi-tractor-trailer truck is variously known as a transport truck, semi-trailer truck, tractor-trailer truck, semi-tractor truck, semi-truck, trailer truck, tractor truck, transfer truck, articulated truck, artic, single truck, semi-tractor-trailer, semi-trailer, tractor-trailer, semi-tractor, semi, trailer, tractor, big rig, eighteen-wheeler or articulated lorry, depending on the country and region.

Semi-trailers comprise landing gear assemblies that allow for the raising, lowering and support of the forward end or nose portion of the trailer in the engagement and disengagement from the tractor unit (also called a prime mover) and allows the trailer to be freestanding whilst not in transit. In most instances, the trailer itself is decoupled from a prime mover and then re-coupled to either the same prime mover, a different prime mover, a shunt truck, a converter dolly etc., depending on the logistics appropriate to the use.

A typical scenario is where a trailer is delivered to a loading dock for loading or unloading. The prime mover positions the trailer in the loading dock. The operator will de-latch the kingpin from the fifth wheel (alternatively known as the turntable) and disconnect the service lines. The operator will then manually lower the legs of the landing gear. The operator will then raise the forward end of the trailer to clear the trailer king pin from the fifth wheel of the prime mover. Once the trailer king pin is clear of the prime mover fifth wheel, the prime mover can be driven clear of the trailer to leave the trailer freestanding. The prime mover is then typically utilized elsewhere in a more productive role than being idle whilst the trailer is loaded or unloaded. The trailer will then be loaded or unloaded which may take a portion of an hour or it may take several days. The trailer will typically be loaded up to twenty tons in weight, and in some instances up to twenty-five tons, on one trailer. Once the trailer is loaded or unloaded, a prime mover will then return to the trailer for removal of the trailer from the loading dock.

Landing gear assemblies for trailers are not typically designed to accommodate the weight of a fully loaded trailer, let alone the dynamic forces generated by a forklift moving through a partially loaded trailer. The high center of gravity associated with most trailers makes the likelihood of tipping over a real possibility. Tipping may also occur when the pavement or ground under a trailer is uneven or when the asphalt hollows or has other unforeseen irregularities.

In addition, the landing gear assemblies of semi-trailers are typically made of metal, such as steel, which eventually corrodes. Furthermore, current landing gear assemblies are often welded onto the trailer. Welds are difficult to inspect and are known to crack when stressed. Corrosion of landing gear and cracking of landing gear welds may lead to failure of the landing gear. Under certain conditions of loading or unloading, there is a potential for the landing gear of the trailer, especially if faulty or rusted, to collapse under extreme weight conditions resulting in the trailer nose diving or tipping over. An unsupported trailer can collapse or tip over, for example, with fork-truck and driver inside, creating a hazardous situation for the fork truck driver, as well as for any personnel on the ground around the outside of the trailer. Trailer nose diving or tip over can be very costly with injuries to employees, downtime, and loss of product.

A common way to stabilize free standing trailers is to use a trailer stand. Most trailer stands use a pneumatic jack that is operable and positionable through the hydraulic system of a shunt truck. This type of device requires the operator to hook up, make positioning adjustments, and disconnect the device, while on the bed of the shunt truck. This leaves the operator in a vulnerable position between the cab of the shunt truck and the semi-trailer.

Currently, devices known as “trailer jacks” or “trailer stands” are often used to act as a safety support under the front end or nose portion of a trailer when it is being loaded or unloaded with the trailer resting on its landing gear rather than on a tractor, converter dolly, shunt truck etc. Current trailer stands require personnel to position them, and remove them from, under the nose portion of the trailer either directly (i.e., manually) or indirectly via, for example, a shunt truck. This leaves the operating personnel in a vulnerable and dangerous position around and/or under the trailer, especially if it were to tip over or nosedive.

Therefore, there is a need for an easy-to-use, reliable auxiliary support that is capable of supporting a trailer if and when its landing gear collapses and preventing such a trailer from tipping over or nose diving, which auxiliary support does not require personnel to position the support under, or to remove the support from underneath, the trader when the trailer is freestanding on its landing gear.

The discussion of the background herein is included solely to explain the context of the invention described herein. This is not to be taken as an admission that any of the material referred to was published, known, or part of the common general knowledge as of the priority date of any of the claims.

### SUMMARY OF THE INVENTION

The present invention overcomes the disadvantages of, and problems associated with, prior art trailer supports, including current trailer stands.

In accordance with an aspect of the present invention, there is provided a trailer-mountable retractable trailer support assembly comprising one or more moveable or displaceable support members that when lowered to their operable position underneath a trailer, are capable of supporting and/or stabilizing the trailer and that when raised to their stored position, do not interfere with connecting the trailer to a prime or auxiliary mover or with transportation.

In accordance with another aspect of the present invention, there is provided a trailer-mountable retractable trailer support assembly comprising one or more moveable or displaceable support members that are moveable between a raised position wherein the support members are retracted away from the ground surface towards the underside of the trailer and are in a stored position and a lowered position wherein the support members are extended away from the underside of the trailer towards the ground surface and are in a supporting and/or stabilizing position to support and/or stabilize the trailer.

In accordance with another aspect of the present invention, there is provided a trailer-mountable retractable trailer support assembly comprising: a mounting assembly for mounting the support assembly to the underside of a trailer, one or more moveable support members moveably attached to the mounting assembly, wherein the support members are moveable between a first raised position wherein the support members are retracted away from the ground surface towards the underside of the trailer in a stored position, and a second lowered position wherein the support members are extended away from the underside of the trailer towards the ground surface and are in an operable supporting position wherein they are capable of supporting the trailer.

In accordance with another aspect of the present invention, there is provided a trailer-mountable retractable trailer support assembly comprising: a mounting assembly for mounting the support assembly to the underside of a trailer and one or more moveable support members moveably attached to the mounting assembly. In an embodiment, the one or more moveable support members are selectively moveable between a raised, retracted or stored position, wherein the support members are retracted away from the ground surface and towards the underside of the trailer such that they are positioned adjacent to the underside of the trailer and do not interfere with connecting the trailer to a prime or auxiliary mover or with transportation, and a lowered, extended or operable position, wherein the support members are extended such that they are positioned substantially vertically and are capable of supporting the trailer if and when its landing gear collapses or fails and prevents such a trailer from tipping over or nose diving. In an embodiment, the one or more moveable support members comprise one more supporting legs. In an embodiment, the one or more moveable support members is a single supporting leg, which when a trailer is parked at the loading dock and the single supporting leg is lowered to its second operable position, the single supporting leg is positioned under the approximate center of the trailer substantially equidistant from the sides of the trailer. In another embodiment, the one or more moveable support members comprise a pair of supporting legs, which when a trailer is parked at the loading dock and the pair of supporting legs are lowered to their second operable position, each supporting leg is positioned under the trailer substantially equidistant from the respective sides of the trailer.

In accordance with an aspect of the present invention, there is provided a trailer-mountable retractable trailer support assembly for supporting a trailer, the assembly comprising: (a) a stationary mounting assembly for mounting to the underside of the trailer; and (b) one or more displaceable or moveable support members moveably attached to the stationary mounting assembly and moveable between a first storage position to a second supporting position capable of supporting the trailer.

In an embodiment, the support assembly further comprises a moving assembly associated with the one or more displaceable or moveable support members for allowing movement of the one or more support members between the first and second positions.

In an embodiment, the moving assembly has one end connected to the stationary mounting assembly and another end connected to the one or more displaceable support members for allowing movement of the support members between the first and second positions.

In an embodiment, the moving assembly is a pivot assembly.

In an embodiment, the one or more displaceable or moveable support members are pivotally attached to the stationary mounting assembly.

In accordance with an aspect of the present invention, there is provided a trailer-mountable retractable trailer support assembly for supporting a trailer, the support assembly comprising: (a) a stationary mounting assembly for mounting to the underside of the trailer; (b) one or more displaceable or moveable support members co-operating with the stationary mounting assembly, and moveable between a first stored position to a second support position so as to be capable of supporting the trailer; and (c) a moving assembly associated with the one or more displaceable or moveable support members for allowing movement of the support members from the first stored position to the second support position, wherein the moving assembly is connected at one end to the stationary mounting assembly and connected at another end to the support members for allowing movement of the support members between said positions.

In an embodiment, the moving assembly is a pivot assembly.

In an embodiment, the cooperation between the one or more displaceable or moveable support members and the stationary mounting assembly is a pivotal cooperation.

In accordance with an aspect of the present invention, there is provided a trailer-mountable retractable trailer support assembly for supporting a trailer, the support assembly comprising: (a) a stationary mounting assembly for mounting on the underside of the trailer; (b) one or more displaceable or moveable support members co-operating with the stationary mounting assembly and moveable between a first stored position and a second support position so as to be capable of supporting the trailer; and (c) a moving assembly associated with the one or more displaceable or moveable support members for allowing movement of the support members from the first stored position, wherein the support members are retracted towards the underside of the trailer to the second support position.

In an embodiment, the one or more displaceable support members comprise a pair of supporting leg members.

In an embodiment, one end of each of the supporting leg members is pivotably attached to the stationary mounting assembly and the other end of each of the supporting leg members is displaceable relative to the stationary mounting assembly.

In an embodiment, the moving assembly is a pivot assembly for allowing pivoting of the one or more displaceable support members between the first storage position and the second supporting position.

In accordance with an aspect of the present invention, there is provided a trailer-mountable retractable trailer support assembly for supporting a trailer, the support assembly comprising: (a) a stationary mounting assembly comprising an upper surface and a lower surface wherein the upper surface is for mounting to the underside of the trailer; (b) one or more displaceable or moveable support members connected to the lower surface of the stationary mounting assembly wherein the support members are moveable relative to the stationary mounting assembly, the support members comprising a pair of supporting leg members, each supporting leg member having an upper end moveably secured to the lower surface of the stationary mounting assembly and a lower free end displaceable relative to the stationary mounting assembly; and (c) a pair of a moving assemblies, each moving assembly associated with one supporting leg member and having one end connected to the stationary mounting assembly and the other end connected to the upper end of the supporting leg member.

In an embodiment, the upper end of each supporting leg member is pivotably secured to the lower surface of the stationary mounting assembly.

In an embodiment, the pair of moving assemblies is a pair of pivot assemblies.

In accordance with an aspect of the present invention, there is provided a trailer-mountable support assembly for supporting a parked trailer having a landing gear, the support assembly comprising a mounting assembly for mounting to the underside of the trailer and a frame assembly pivotably connected to the mounting assembly wherein the frame assembly is pivotable between a lowered operable position wherein the frame assembly is substantially vertical and is capable of supporting the parked trailer if its landing gear fails and a raised stored position wherein the frame assembly is raised away from the vertical towards the underside of the trailer.

In accordance with an aspect of the present invention, there is provided a trailer-mountable support assembly for supporting a parked trailer, the support assembly comprising a mounting assembly for mounting to the underside of the trailer and a leg assembly pivotably connected to the mounting assembly wherein the leg assembly is pivotable between a raised stored position, wherein the leg assembly is raised towards the underside of the trailer and a lowered operable position wherein the leg assembly is lowered away from the underside of the trailer and is vertical and is capable of supporting the trailer.

In accordance with an aspect of the present invention, there is provided a trailer-mountable support assembly for supporting and/or stabilizing a trailer that nose dives or tips during the loading or unloading of goods transported by the trailer, the support assembly comprising a mounting assembly for mounting to the underside of the trailer and a leg assembly selectively moveable between a transport position wherein the leg assembly is retracted towards the underside of the trailer and a supporting and/or stabilizing position wherein the leg assembly is extended vertically.

In an embodiment, the leg assembly comprises one or more supporting and/or stabilizing legs.

In an embodiment, the leg assembly comprises two supporting and/or stabilizing legs, each supporting and/or stabilizing leg is mountable adjacent each side of the trailer.

In an embodiment, each supporting and/or stabilizing leg is mountable forward of the trailer's landing gear.

It is understood that one or more of the aspects described herein (and above) may be combined in any suitable manner. The novel and inventive features of the present invention will become apparent to those of skill in the art upon examination of the following detailed description of the invention. It should be understood, however, that the detailed description of the present invention and the specific examples presented, while indicating certain aspects of the invention, are provided for illustration purposes only because various changes and modifications within the spirit and scope of the invention will become apparent to those of skill in the art from the detailed description of the invention and claims that follow.

In an embodiment, the present invention provides a trailer-mountable auxiliary retractable trailer support assembly that when deployed in its operable position is capable of supporting and stabilizing a freestanding trailer if and when its landing gear fails and thus, is capable of preventing the trailer from nosediving or tipping over.

In an embodiment, the present invention provides a trailer-mountable auxiliary trailer support assembly that does not require welding to mount the assembly to the underside of the trailer.

In an embodiment, the present invention provides a trailer-mountable auxiliary trailer support assembly that replaces the need for a manually placed trailer stand and does not require an operator to position or adjust when the trailer is freestanding only supported by its landing gear (i.e., “no boots on the ground”).

In an embodiment, the present invention provides a trailer-mountable auxiliary trailer support assembly that is retrofittable to existing trailers.

In an embodiment, the present invention provides an auxiliary support for a trailer in case of landing gear failure.

In an embodiment, the present invention provides a second set of legs for a trailer in case of landing fear failure.

In an embodiment, the present invention provides an auxiliary support for a trailer, wherein the support may be deployed to its operable supporting position before the trailer is removed from its prime or auxiliary mover and the trailer is left freestanding upon its landing gear.

In an embodiment, the present invention provides a trailer-mountable auxiliary trailer support assembly, that is easy to deploy to its operable supporting position and is easy to retract to its storage position for highway transport.

In an embodiment, the present invention provides a foldable auxiliary trailer support assembly for a trailer of a tractor trailer or similar vehicle, the assembly being simple in construction, involving relatively few parts, and being operated by the pivoting of the assembly continuously in a single direction for raising the assembly from its lowered and extended operating position to its raised and folded stored position, and continuously in the opposite direction for lowering the assembly from its raised and folded stored position to its lowered and extended operating position.

In an embodiment, the present invention provides a foldable auxiliary trailer support assembly for a trailer of a tractor trailer or similar vehicle, the assembly involving relatively inexpensive components, being reliable in operation, being locking when in its raised and folded stored position and in its lowered and extended operating position, and requiring a relatively small amount of force to raise and lower the assembly.

In an embodiment, the present invention provides a foldable auxiliary trailer support assembly for a trailer of a tractor trailer or similar vehicle, the assembly being rugged in construction, being retractable to a substantially non-obstructing position beneath the trailer, and being operable to quickly lower and extend its support to its operating vertical position when required so as to safely support the trailer when it is detached from its prime or auxiliary mover if and when the trailer nose dives or tips over, for example, during loading and/or unloading.

In an embodiment, the present invention provides a foldable auxiliary trailer support assembly for a trailer of a tractor trailer or similar vehicle, the assembly being compact in size, having a low profile, and being operable in a relatively simple manner by means of an operator unlocking and pivoting the assembly.

Further objects and advantages of the invention will become apparent from the following description and claims, and from the accompanying drawings, wherein:

### BRIEF DESCRIPTION OF THE DRAWINGS

The present invention will be further understood from the following description with reference to the Figures, in which:

FIG. 1 is an isometric view of an exemplary trailer-mountable support system for a trailer in the lowered position.

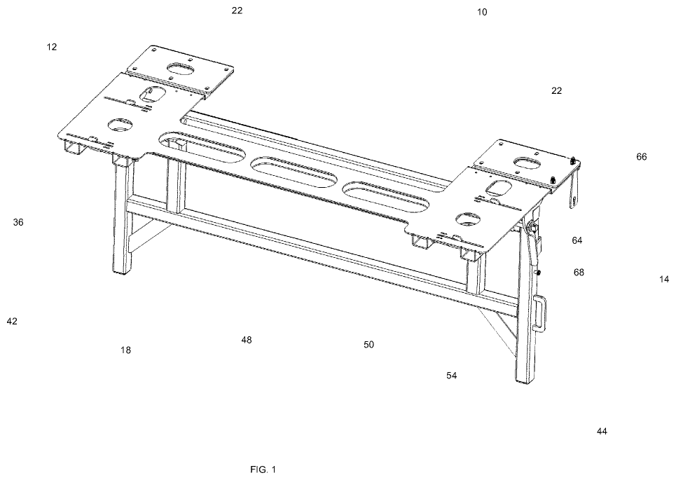

FIG. 2 is an exploded view of the trailer-mountable support system of FIG. 1.

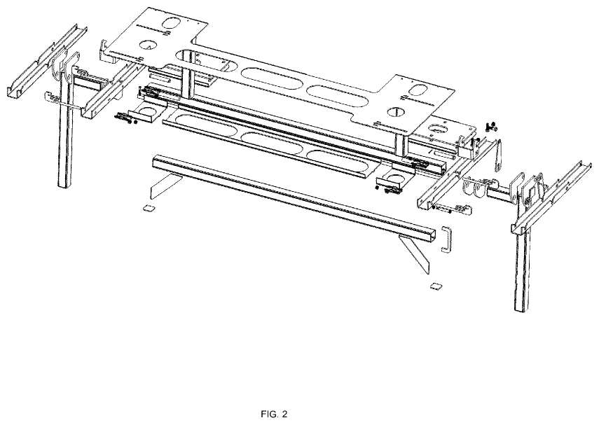

FIG. 3 is a front view of the trailer-mountable support system of FIG. 1.

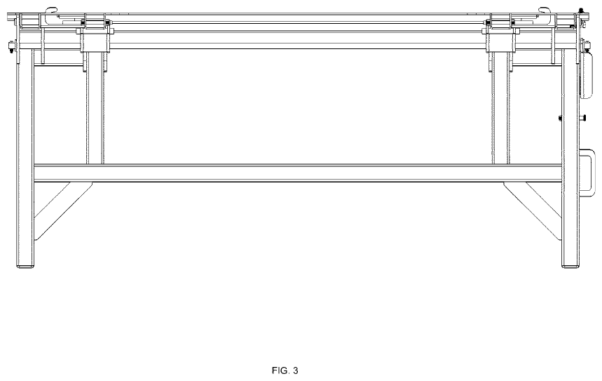

FIG. 4 is a front perspective view of the trailer-mountable support system of FIG. 1.

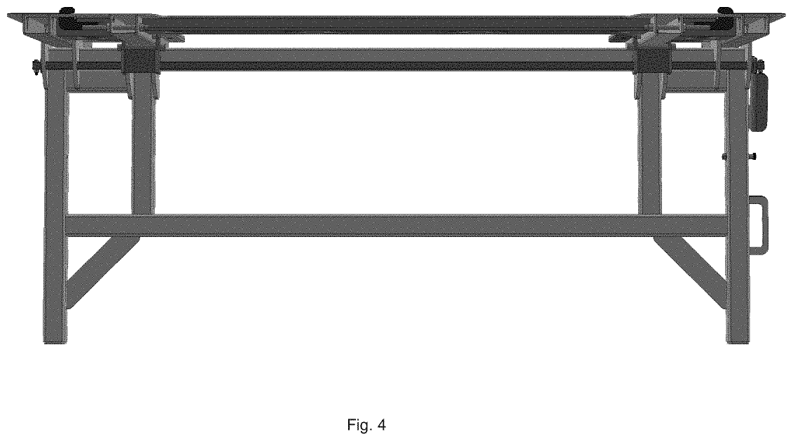

FIG. 5 is a rear view of the trailer-mountable support system of FIG. 1.

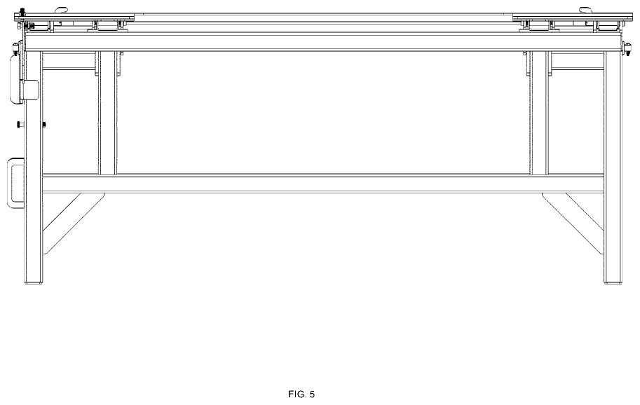

FIG. 6 is rear perspective view of the trailer-mountable support system of FIG. 1.

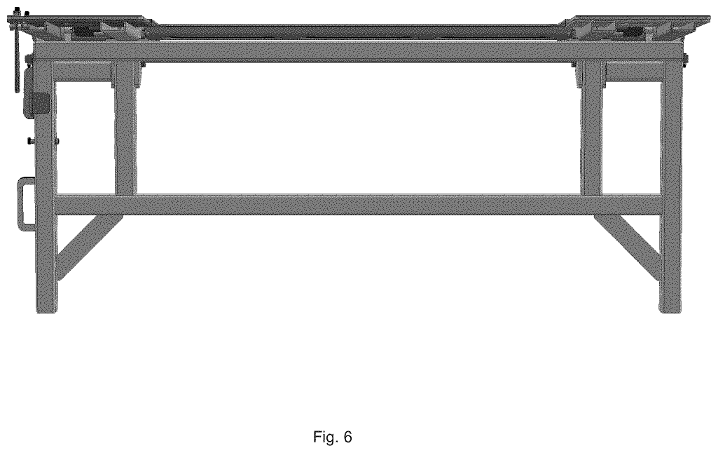

FIG. 7 is a top view of the trailer-mountable support system of FIG. 1.

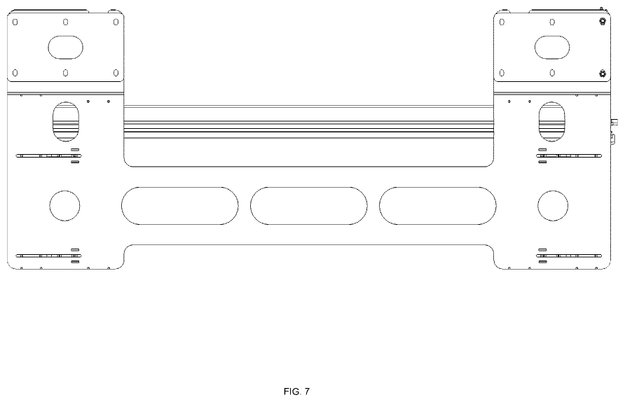

FIG. 8 is a top perspective view of the trailer-mountable support system of FIG. 1.

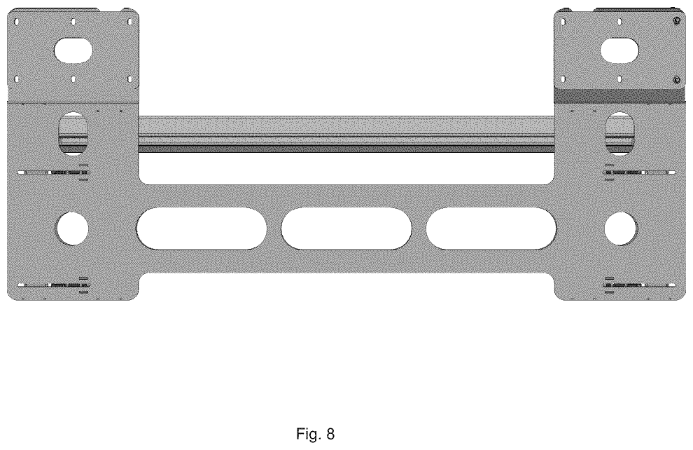

FIG. 9 is a bottom view of the trailer-mountable support system of FIG. 1.

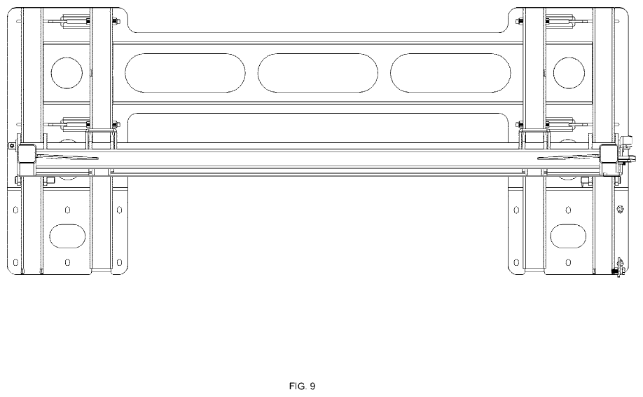

FIG. 10 is a bottom perspective view of the trailer-mountable support system of FIG. 1.

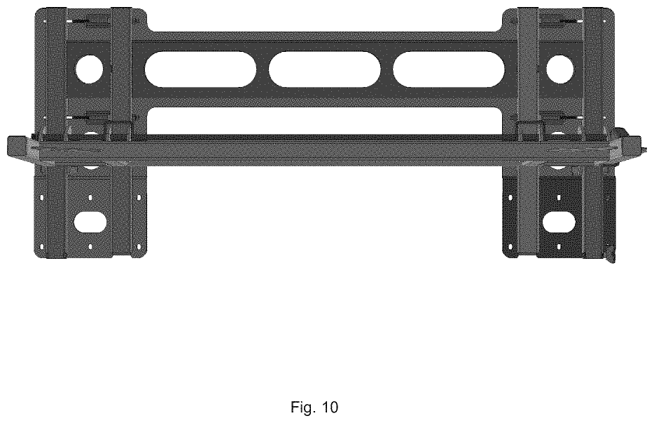

FIG. 11 is a left-side view of the trailer-mountable support system of FIG. 1.

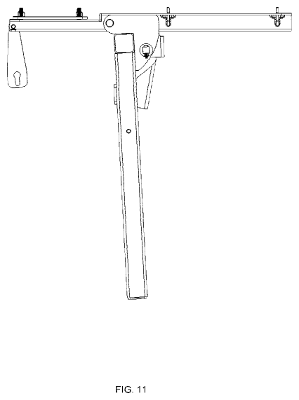

FIG. 12 is a left-side perspective view of the trailer-mountable support system of FIG. 1.

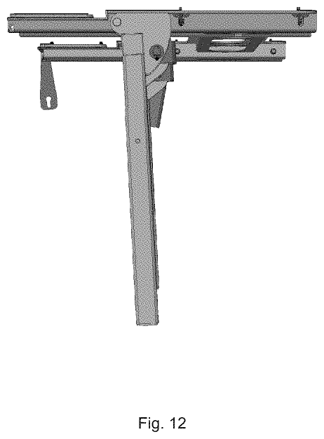

FIG. 13 is a right-side view of the trailer-mountable support system of FIG. 1.

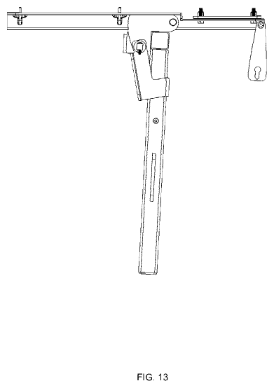

FIG. 14 is a right-side perspective view of the trailer-mountable support system of FIG. 1.

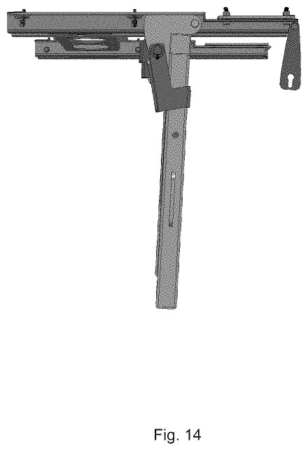

FIG. 15 is an isometric view of an exemplary trailer-mountable support system installed on a trailer in the lowered position.

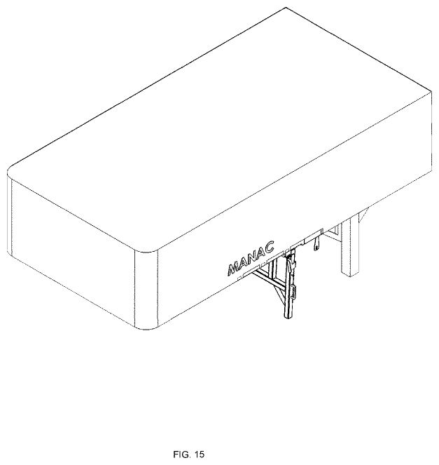

FIG. 16 is a front view of the trailer-mountable support system of FIG. 15.

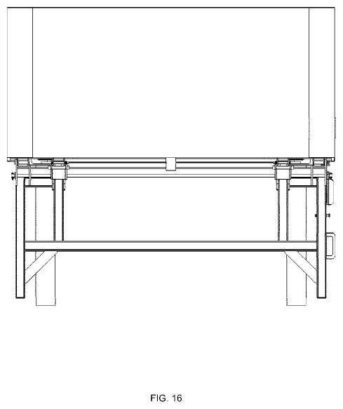

FIG. 17 is a rear view of the trailer-mountable support system of FIG. 15.

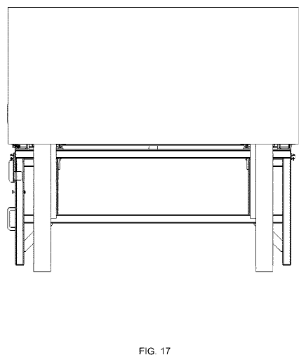

FIG. 18 is a bottom view of the trailer-mountable support system of FIG. 15.

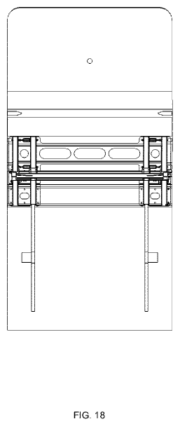

FIG. 19 is a left-side view of the trailer-mountable support system of FIG. 15.

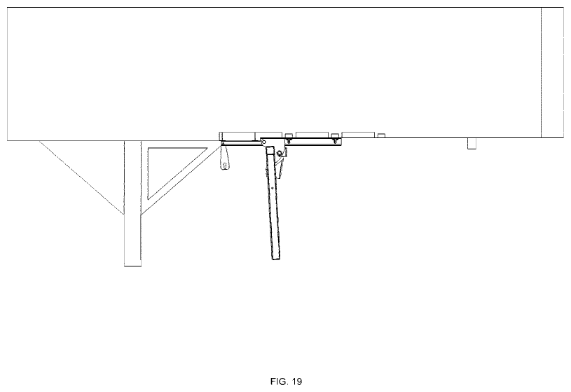

FIG. 20 is a right-sided view of the trailer-mountable support system of FIG. 15.

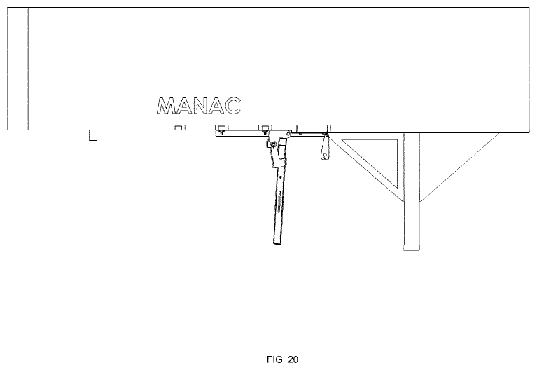

FIG. 21 is an isometric view of an exemplary trailer-mountable support system for a trailer in the raised position.

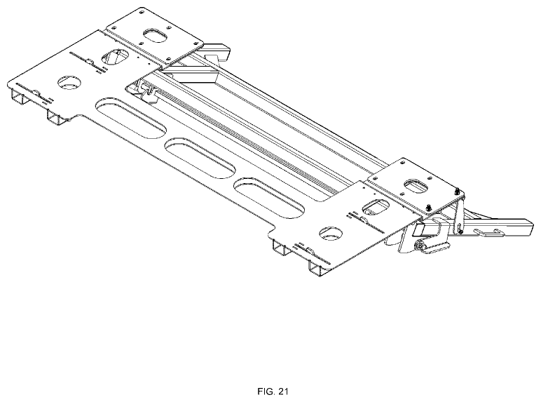

FIG. 22 is a front view of the trailer-mountable support system of FIG. 21.

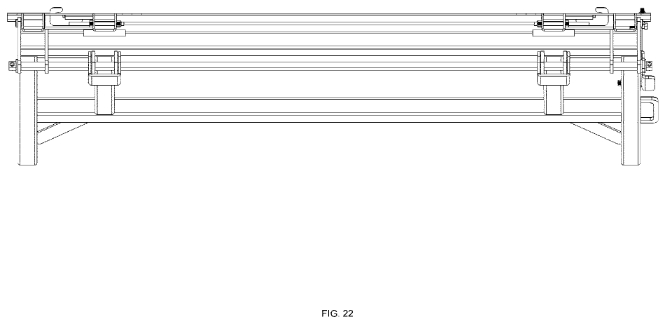

FIG. 23 is a rear view of the trailer-mountable support system of FIG. 21.

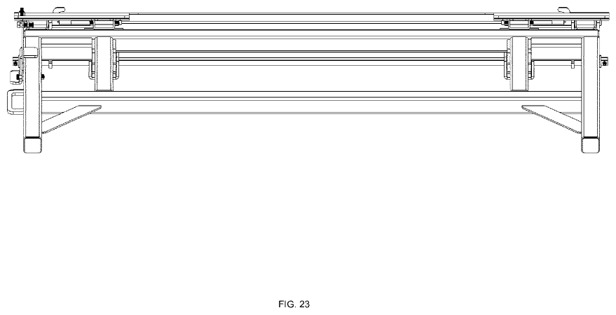

FIG. 24 is a top view of the trailer-mountable support system of FIG. 21.

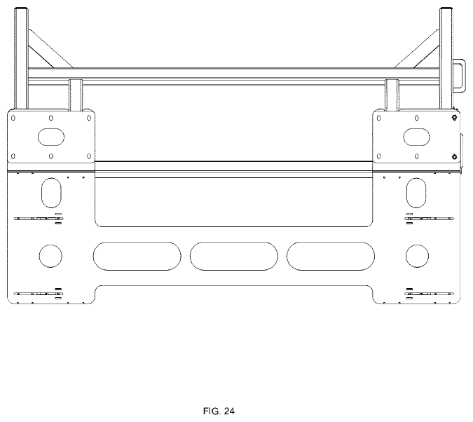

FIG. 25 is a bottom view of the trailer-mountable support system of FIG. 21.

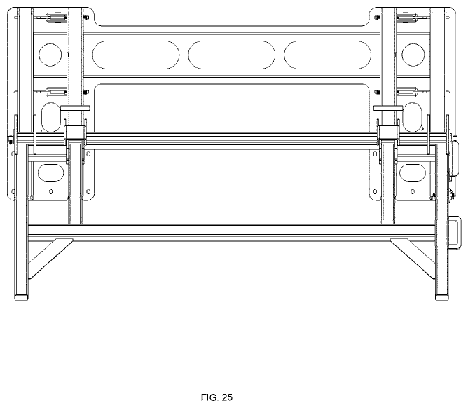

FIG. 26 is a left-side view of the trailer-mountable support system of FIG. 21.

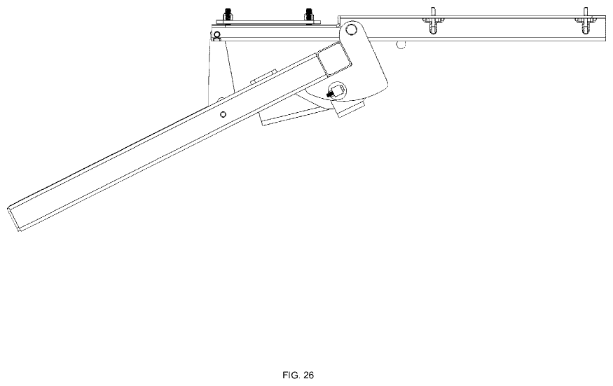

FIG. 27 is a right-side view of the trailer-mountable support system of FIG. 21.

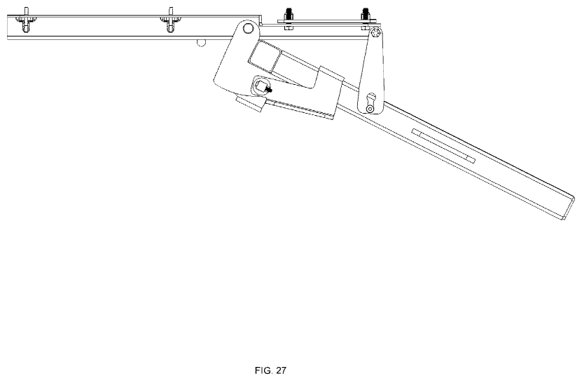

FIG. 28 is a left-side view of an exemplary trailer-mountable support system installed on a trailer in the raised position.

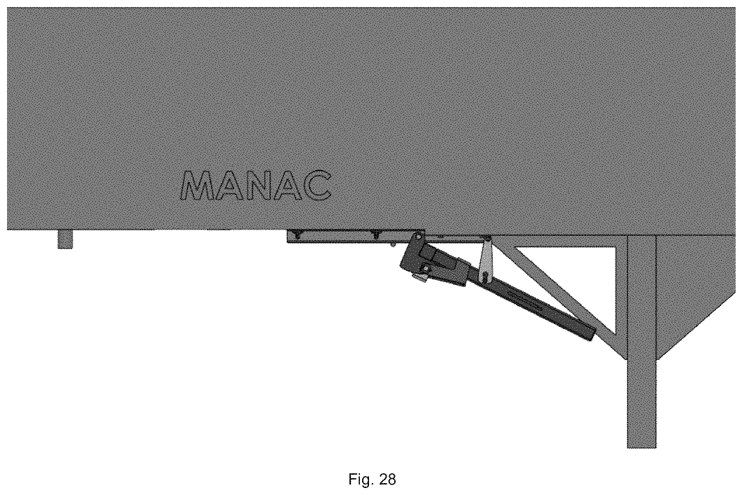

FIG. 29 is a left-side view of an exemplary trailer-mountable support system installed on a trailer in the raised position when the trailer is attached to a fifth-wheel.

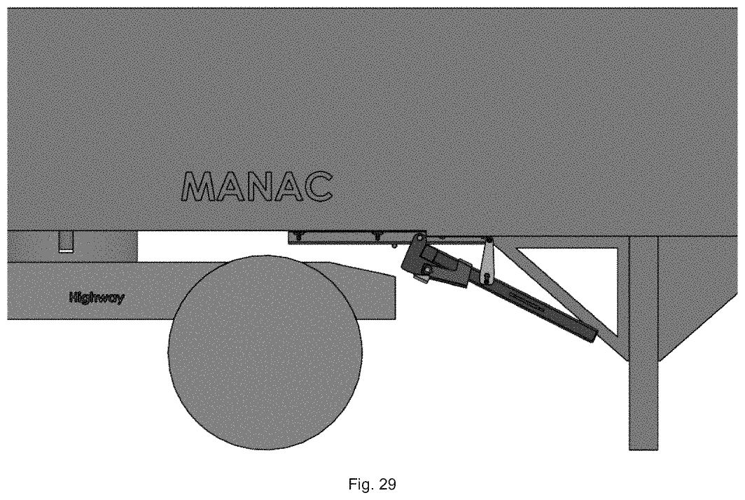

FIG. 30 is a left-side view of an exemplary trailer-mountable support system installed on a trailer in the lowered position indicating exemplary, but non-limiting, dimensions.

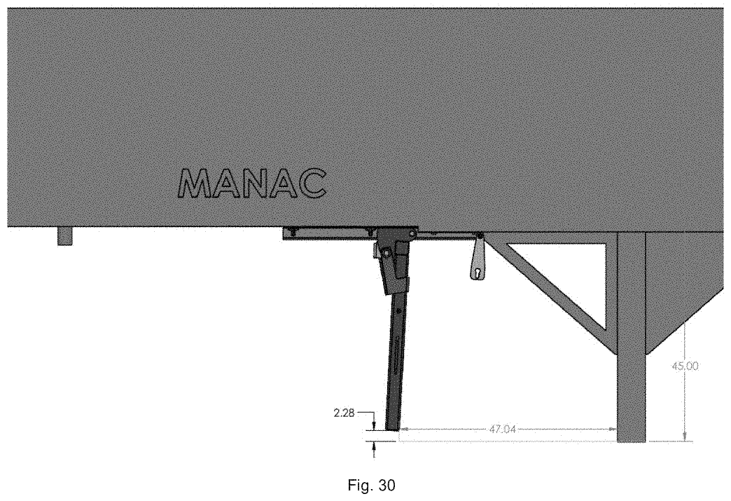

### DETAILED DESCRIPTION OF EMBODIMENTS OF THE INVENTION

Referring now to the drawings and the illustrative embodiments depicted therein, there is shown a trailer-mountable retractable trailer support assembly 10 of the present invention for mounting to the underside surface of a trailer.

FIG. ? generally illustrates the trailer-mountable retractable trailer support assembly 10 of the present invention in a raised, retracted, folded or stored position, wherein the trailer support assembly 10 is retracted towards the underside of the trailer and for example, does not obstruct or interfere with connecting the trailer with a primer or auxiliary mover.

FIG. ? generally illustrates the trailer-mountable retractable trailer support assembly 10 of the present invention in a lowered, extended or operable position, wherein the trailer support assembly 10 is capable of supporting a trailer if and when its landing gear fails or collapses and thus is capable of preventing such a trailer from tipping over or nose diving.

In an embodiment, the trailer-mountable support assembly 10 comprises a mounting assembly 12 for mounting to the underside of a trailer and a moveable or displaceable frame (or drop leg) assembly 14 capable of being moved, relative to the mounting assembly, between a first, raised, retracted, folded, stowed, stored or transport position, wherein the moveable or displaceable frame assembly is oriented towards the horizontal and thus towards the mounting assembly and the underside of the trailer (when mounted), and a second, lowered, extended, unfolded, deployed, operable, supporting or stabilizing position, wherein the moveable or displaceable frame assembly is substantially vertically oriented and thus is substantially orthogonal to the mounting assembly and thus the underside of the trailer (when mounted). The terms “first”, “raised”, “retracted”, “folded”, “stowed”, “stored” or “transport” position as used herein to describe the orientation of the frame assembly, i.e., oriented towards the horizontal and thus towards the mounting assembly and the underside of the trailer (when mounted), are used interchangeably. The terms “second”, “lowered”, “extended”, “unfolded”, “deployed”, “operable”, “supporting” or “stabilizing” position as used herein to describe the orientation of the frame assembly, i.e., substantially vertically oriented and thus substantially orthogonal to the mounting assembly and thus the underside of the trailer (when mounted), are used interchangeably. The terms “substantially vertically” and “substantially orthogonal”, as used herein mean from about −5 degrees to about +5 degrees relative to vertical.

In an embodiment, the mounting assembly comprises a mounting plate assembly 16.

The mounting plate assembly has an upper surface, a lower surface, a front end, a rear end, a left end and a right end. The upper surface of the mounting plate assembly is for abutting with, and for mounting to, the underside of the trailer. The lower surface of the mounting plate assembly is for connecting the various components of the trailer support assembly thereto. The left end of the mounting assembly is for mounting to the underside of the trailer proximate the left side of the trailer and the right end of the mounting assembly is for mounting to the underside of the trailer proximate the right side of the trailer such that the trailer support assembly transverses the width of the trailer.

In an embodiment, the mounting plate assembly is composed of a single component. In another embodiment, the mounting plate assembly is composed of a plurality of components.

In an embodiment, the mounting plate assembly is a substantially “H”-shaped flat plate member wherein the left and right members located at the respective left and right ends of the mounting plate assembly provide the left and right arms of the “H”-shape, respectively and an intermediate member connecting the left and right members provides the centre connecting arm of the “H”-shape.

In an embodiment, the upper surfaces of the rear ends of the left and right ends of the mounting plate assembly are recessed relative to the upper surface of the rest of the mounting plate assembly such that step is formed in the transition from the upper surfaces of the rear ends of the left and right ends of the mounting plate assembly to the upper surface of the rest of the mounting plate assembly. In an embodiment, this step will accommodate one of the multiple horizontally spaced apart support ribs on the underside of the trailer running across the entire width of the trailer when the mounting plate assembly is mounted to the underside of the trailer.

Although the mounting plate assembly is shown having an “H”-shape, the mounting plate assembly may have any shape known to persons skilled in this art that could perform the same function.

In an embodiment wherein the mounting plate assembly is made up of a plurality of components, the mounting plate assembly may comprise a main mounting plate 18, one or more bent mounting plates 20, for example, two bent mounting plates—a left bent mounting plate and a right bent mounting plate, and one or more clamping mounting plates 22, for example, two clamping mounting plates—a left clamping plate and a right clamping plate.

In an embodiment, the main mounting plate has an upper surface, a lower surface, a front end, a rear end, a left end and a right end. The upper surface of the main mounting plate is for abutting with, and mounting to, the underside of the trailer.

In an embodiment, the main mounting plate is a substantially “H”-shaped flat plate member wherein the left and right members located at the respective left and right ends of the main mounting plate provide the left and right arms of the “H”-shape, respectively and an intermediate member connecting the left and right members provides the centre connecting arm of the “H”-shape. Although the main mounting plate is shown having an “H”-shape, the main mounting plate may have any shape known to persons skilled in this art that could perform the same function.

In an embodiment, the main mounting plate has one or more cut outs formed therein, for example, to reduce the weight of the main mounting plate, without affecting the strength and rigidity of the main mounting plate and, for example, to allow access to the underside of the trailer through the main mounting plate. In the embodiment shown, the main mounting plate has seven cut outs formed therein, including three oval cut outs formed in the intermediate member and one oval cut out and one circular cut out formed in each of the left and right members, respectively. However, the main mounting plate may have no cut outs formed therein or any number of cut outs and shapes of cut outs formed therein as would be understood by persons skilled in this art.

In an embodiment, the main mounting plate comprises one or more wedge clip assemblies 24, for example, for further securing the main mounting plate to the underside of the trailer. In an embodiment, the wedge clip assembly comprises a wedge clip assembly retaining plate 26, a wedge clip 28, a wedge clip retaining plate 30, and a threaded rod 32. In an embodiment, the wedge clip assembly retaining plate is mounted on the lower surface of the main mounting plate. In an embodiment, the wedge clip is retained in the wedge clip assembly by the wedge clip retaining plate. In an embodiment, the main mounting plate has a slot formed therein through which the wedge clip protrudes from the lower surface of the main mounting plate to extend above the upper surface of the main mounting plate. In an embodiment, the portion of the wedge clip that extends above the upper surface of the main mounting plate is in the shape of a bent finger which, in an embodiment, may engage with a structure on the underside surface of the trailer to further secure the main mounting plate to the underside of the trailer. In an embodiment, the threaded rod adjusts the position of the wedge clip within the slot of the main mounting plate to facilitate engagement of the wedge clip with, and release from, the structure on the underside surface of the trailer. In the embodiment shown, the main mounting plate comprises four wedge clip assemblies, two wedge clip assemblies on each of the left and right arms of the main mounting plate. However, the main mounting plate may have no wedge clip assemblies or any number of wedge clip assemblies as would be understood by persons skilled in this art.

In an embodiment, the left bent mounting plate has a substantially rectangular shape and has an upper surface, a lower surface, a front end, a rear end, an outer end and an inner end. The front end of the left bent mounting plate is bent to provide the step in the mounting plate assembly for accommodating a support rib on the underside of the trailer, as discussed above. The left bent mounting plate is connected via its front bent end to the rear end of the left arm of the main mounting plate via welding or the like.

In an embodiment, the right bent mounting plate has a upper surface, a lower surface, a front end, a rear end, an outer end and an inner end. The front end of the right bent mounting plate is bent to provide the step in the mounting plate assembly for accommodating a support rib on the underside of the trailer, as discussed above. The right bent mounting plate is connected via its front bent end to the rear end of the right arm of the main mounting plate via welding or the like.

In an embodiment, the left and right bent mounting plates have a cut out in the rear end thereof proximate the inner end and as such, in this embodiment, the left and right bent mounting plates are mirror images of each other.

In an embodiment, the left and right bent mounting plates have one more apertures formed therein, for example, for mounting to the underside of the trailer via fasteners, such as, for examples, bolts or the like. In the embodiment shown, the left and right bent mounting plates comprises six mounting apertures. However, the left and right bent mounting plates may have any number of mounting apertures as would be understood by persons skilled in this art. In an embodiment, the left and right bent mounting plates have one or more cut outs formed therein, for example, to reduce the weight of the left and right bent mounting plates, without affecting the strength and rigidity of the left and right bent mounting plates and, for example, to allow access to the underside of the trailer through the left and right bent mounting plates. In the embodiment shown, the left and right bent mounting plates have one oval cut out formed therein. However, the left and right bent mounting plates may have no cut outs formed therein or any number of cut outs, and shapes of cut outs, formed therein as would be understood by persons skilled in this art.

In an embodiment, the left and right clamping plates are identical and have an upper surface, a lower surface, a front end, a rear end, an outer end and an inner end. In an embodiment, the left and right clamping plates are rectangular flat plate members. The lower surfaces of the left and right clamping plates are for abutting with, and for connecting to, the upper surfaces of the left and right bent mounting plates, respectively. The upper surfaces of the left and right clamping plates are for abutting with, and for mounting to, the underside surface of the trailer. The left and right clamping plates comprise mounting apertures that align with the mounting apertures of left and right bent mounting plates, respectively, for mounting to the underside surface of the trailer, as discussed above.

In an embodiment, the left and right clamping plates have one or more cut outs formed therein, for example, to reduce the weight of the left and right claiming plates, without affecting the strength and rigidity of the left and right clamping plates. In an embodiment, the one or more cut outs formed in the left and right clamping plates align with the one or more cut outs formed in the left and right bent mounting plates, respectively, for example, to allow access to the underside of the trailer through the aligned cut outs in the left and right bent mounting plates and the left and right clamping plates, respectively. In the embodiment shown, the left and right clamping plates have one oval cut out formed therein. However, the left and right clamping plates may have no cut outs formed therein or any number of cut outs, and shapes of cut outs, formed therein as would be understood by persons skilled in this art.

In an embodiment, the mounting assembly may also comprise one or more separators/stiffeners 34, for example, to provide additional strength and rigidity to the main mounting plate. The one or more separators/stiffeners have an upper surface, a lower surface, a front end, a rear end, a left end, and a right end. The upper surface of the one or more separators/stiffeners is for abutting with, and mounting to, the lower surface of the main mounting plate. In an embodiment, the mounting assembly comprises one long separator/stiffener mounted, for example, along the lower surface of the intermediate member of the main mounting plate, and two short, separators/stiffeners, a left short separator/stiffener mounted, for example, on the lower surface of the left end member of the main mounting plate, and a right short separator/stiffener mounted, for example, on the lower surface of the right end member of the main mounting plate. In an embodiment, the one or more separators/stiffeners are substantially rectangular plate members with a substantially “U”-shaped cross-section. However, the one or more separators/stiffeners may have any shape known to persons skilled in this art that could perform the same function. In an embodiment, the one or more separators/stiffeners have one or more cut outs formed therein, for example, to reduce the weight of the separator/stiffener, without affecting the strength and rigidity of the separator/stiffener and, for example, align with the one or more cut outs formed in the main mounting plate, to, for example, allow access to the underside of the trailer through the separator/stiffener and the main mounting plate. In the embodiment shown, the long separator/stiffener has three oval cut outs formed therein that align with the three oval cut outs formed in the intermediate member of the main mounting plate and each of the left and right short separator/stiffener has a single circular cut out formed therein that aligns with the circular cut out formed in the left and right end members of the main mounting plate, respectively. However, the one or more separators or stiffeners may have no cut outs formed therein or any number of cut outs, and shapes of cut outs, formed therein as would be understood by persons skilled in this art.

In an embodiment, the mounting assembly may also comprise one or more supporting ribs 36, for example, to provide additional strength and rigidity to the main mounting plate. The one or more supporting ribs have an upper surface, a lower surface, a front end, a rear end, an outer side, and an inner side. In an embodiment, the one or more supporting ribs are substantially rectangular plate members with a substantially “U”-shaped cross-section. However, the one or more supporting ribs may have any shape known to persons skilled in this art that could perform the same function. The ends of the outer and inner sides of the one or more supporting ribs is for abutting with, and mounting to, the lower surface of the main mounting plate by, for example, welding and/or keying or the like. In the embodiment shown, the mounting assembly comprises four supporting ribs, two left end supporting ribs, an outer left end supporting rib and an inner left end supporting rib, mounted in a horizontally spaced apart relationship along the lower surface of the left end member of the main mounting plate from the front end of the main mounting plate to the rear end of the main mounting plate, and two right end supporting ribs, an outer right end supporting rib and an inner right end supporting rib, mounted in a horizontally spaced apart relationship along the lower surface of the right end member of the main mounting plate from the front end of the main mounting plate to the rear end of the main mounting plate. Although four supporting ribs are shown, the mounting assembly may have fewer or more supporting ribs as would be understood by persons skilled in this art.

In an embodiment, the inner end supporting ribs have apertures formed in the outer and inner sides thereof for passage of the threaded rod of the wedge clip assembly as discussed above. The threaded rod of the wedge clip assembly is secured to the inner end supporting ribs via nuts.

In an embodiment, the lower surfaces of the inner end supporting ribs has a slot formed therein for seating the catch bars 38 of the locking assembly as will be discussed in further detail below.

In an embodiment, the outer end supporting ribs have an aperture formed in the outer and inner sides thereof for passage of the pivot pin 40 of the pivot assembly as will be discussed in further detail below.

In an embodiment, the frame assembly has a top end, a bottom end, a left side, a right side, a front face and a rear face.

In an embodiment, the bottom end of the frame assembly is a free end and the top end of the frame assembly is moveably connected to the lower surface of the mounting assembly, with the left side of the frame assembly proximate the left side of the mounting assembly and thus, the left side of the trailer-mountable support assembly, and with the right side of the frame assembly proximate the right side of the mounting assembly and thus, the right side of the trailer-mountable support assembly.

In an embodiment, the frame assembly comprises one or more vertical support (or drop) leg members 42.

In an embodiment, the frame assembly comprises two horizontally spaced apart vertical support leg members, a left vertical support leg member at the left side of the frame assembly and a right vertical support leg member at the right side of the frame assembly. However, the frame assembly may comprise any number of vertical support leg members as would be understood by persons skilled in this art.

In an embodiment, each vertical support leg member is identical having a top end, a bottom end, an outer side, an inner side, a front face and a rear face.

In an embodiment, each vertical support leg member may be of a length such that when the trailer-mountable support assembly is mounted to the underside of a trailer between the kingpin and the landing gear, just forward of the landing gear, when the trailer-mountable support assembly is in its stored position, it does not interfere with the landing gear and when it is in its deployed operable supporting position, the bottom ends of the vertical support leg members are, in one embodiment, about 2 inches to about 12 inches above the ground surface, in another embodiment, about 2 inches to about 4 inches above the ground surface, and in another embodiment, about 4 inches to about 6 inches above the ground surface, and in another embodiment, about 6 inches to about 8 inches, and in another embodiment, about 8 inches to about 10 inches, and in another embodiment, about 10 inches to about 12 inches. For example, a typical distance between the underside surface of a trailer and the ground surface is approximately about 45 inches. When the trailer-mountable support assembly is mounted to the underside of a trailer and is deployed in its operable supporting position, and if and when the trailer's landing gear fails, the bottom ends of the vertical support leg members will engage with, and rest upon, the ground surface thereby supporting and stabilizing the trailer thereupon and preventing the trailer from nosediving or tipping over.

In an embodiment, the outer side of the left and/or the right vertical support leg members may comprise a handle 44 for user operation. In the embodiment shown, the outer side of the right vertical support leg member comprises a handle for user operation. In an embodiment, the handle is shaped and positioned on the outer side of the vertical support leg member so that a user or operator is a safe distance away from being underneath the trailer when deploying and/or storing the trailer-mountable support assembly.

In an embodiment, the frame assembly comprises one or more support members that provide further strength and rigidity to the frame assembly.

In an embodiment, the one or more support members are any number of horizontal support members, any number of vertical support members or a combination of any number of horizontal and vertical support members.

In an embodiment, the one or more support members comprises one or more horizontal beams.

In an embodiment, each horizontal beam has a left end, a right end, an upper face, a lower face, a front face and a rear face.

In an embodiment, the one or more horizontal beams connect the left and right vertical support leg members, traversing the width of the frame assembly. The one or more horizontal beams may be of a width wide enough so that the frame assembly is wide enough to support the full width of a semi-trailer, approximately 66″. However, while the figures show a wide frame assembly, it is understood that the trailer support assembly may accommodate a frame assembly of any width.

In an embodiment, the frame assembly comprises two vertically-spaced apart horizontal beams, an upper horizontal beam 46 located in the upper portion of the frame assembly and a lower horizontal beam 48 in the lower portion of the frame assembly. However, the frame assembly may comprise any number of horizontal beams as would be understood by persons skilled in this art.

In an embodiment, the left end portion of the lower face of the upper horizontal beam sits on top of, and is mounted to, via welding or the like, the top end of the left vertical support leg member and the right end portion of the lower face of the upper horizontal beam sits on top of, and is mounted to, via welding or the like, the top end of the right vertical support leg member such that the upper horizontal beam spans the distance between the left and right sides of the frame assembly.

In an embodiment, the left end of the lower horizontal beam is mounted to, via welding or the like, the inner face of the left vertical support leg member and the right end of the lower horizontal beam is mounted to, via welding or the like, the inner face of the right vertical support leg member such that the lower horizontal beam spans the distance between the left and right vertical support leg members.

In an embodiment, the lower horizontal beam is mounted to the left and right vertical support leg members at a vertically-spaced apart distance from the bottom ends of the left and right vertical support leg members.

In an embodiment, the one or more support members comprises one or more vertical centre posts 50.

In an embodiment, each vertical centre post has a top end, a bottom end, an outer face, an inner face, a front face and a rear face.

In an embodiment, the one or more vertical centre posts connect the upper horizontal beam and the lower horizontal beam traversing the height between them wherein the top end of the one or more vertical centre posts is connected, via welding or the like. to the lower surface of the upper horizontal beam and the bottom end of the one or more vertical centre posts is connected, via welding or the like, to the upper surface of the lower horizontal beam.

In an embodiment, the frame assembly comprises two vertical centre posts, a left vertical centre post located at the left end portion of the frame assembly and a right centre vertical post located at the right end portion of the frame assembly.

In an embodiment, the left vertical centre post is horizontally-spaced apart to the right from the left vertical support leg member and the right vertical centre post is horizontally-spaced apart to the left from the right vertical support leg member.

In an embodiment, the frame assembly comprises one or more additional horizontal support members 52 (i.e., one or more short fillers for drop leg) located between, and connecting, the one or more vertical centre posts and the one or more vertical support leg members and as such, span the distance between the vertical support leg members and the vertical centre posts.

In an embodiment, the one or more additional horizontal support members have an outer end, an inner end, an upper face, a lower face, a front face and a rear face.

In an embodiment, the one or more additional horizontal support members are connected via their upper faces, via welding or the like, to the lower faces of the upper horizontal beam and are connected via their outer and inner ends, via welding or the like, to the inner surfaces of the left and right vertical support leg members and the outer surfaces of the left and right vertical centre posts, respectively.

In an embodiment, the one or more support members, including the one or more vertical support leg members, the one or more horizontal beams, the one or more vertical centre posts, and the one or more additional horizontal support members, are tubular members, having a generally square cross-sectional area. In an embodiment, when the one or more vertical support leg members are tubular members, the bottom ends thereof comprise tube end caps. However, the one or more support members may have any configuration, shape and dimension known to persons skilled in this art that would perform the same function.

In an embodiment, the frame assembly comprises one or more gussets 54 to provide additional strength and rigidity to the frame assembly.

In an embodiment, the frame assembly comprises two gussets, one gusset connected at one end thereof, via welding or the like, to the lower face of the left end portion of the lower horizontal beam and connected at the other end thereof, via welding or the like, to the inner face of the lower end portion of the left vertical support leg member and another gusset connected at one end thereof, via welding or the like, to the lower face of the right end portion of the lower horizontal beam and connected at the other end thereof, via welding or the like, to the inner face of the lower end portion of the right vertical support leg member. Any number of gussets, or no gussets, may be employed. The gussets may be sheet or plate and may be substantially any shape to create the appropriate amount of reinforcement to the frame assembly.

In an embodiment, the frame assembly comprises a pivot assembly for pivotally connecting the frame assembly to the mounting assembly.

In an embodiment, the pivot assembly comprises one or more pivot brackets 56.

In an embodiment, the pivot assembly comprises a pair of horizontally spaced-apart pivot brackets, a left pivot bracket and a right pivot bracket.

In an embodiment, the left and right pivot brackets engage the left and right outer supporting ribs of the mounting assembly, respectively and thus, the pivot brackets are horizontally spaced-apart a distance equal to the distance between the left and right outer supporting ribs of the mounting assembly. Each pivot bracket is identical having a front end, a rear end, an outer face and an inner face.

In an embodiment, the pivot bracket comprises a pair of horizontally spaced-apart pivot bracket side plates, an outer pivot bracket side plate forming the outer face of the pivot bracket and an inner pivot bracket side plate forming the inner side of the pivot bracket. The horizontally spaced-apart pivot bracket side plates define a central gap or channel therebetween within which the left and right outer supporting ribs of the mounting assembly, respectively are received and nest. The width of the gap or channel, i.e., the distance between the outer and inner pivot bracket side plates, equals or slightly exceeds the width of outer supporting rib such to permit the pivot bracket to pivot freely about the outer supporting rib.

In an embodiment, each pivot bracket side plate is identical having an outer surface, an inner surface, a top edge, a bottom edge, a front edge and a rear edge and comprising an upper portion and a lower portion. The upper portion comprises an aperture therethrough for accommodating the pivot pin. The rear edge of the lower portion is recessed back from the rear edge of the upper portion creating a step in the rear of the pivot bracket side pate, wherein the step has a vertical wall and a horizontal floor. The step accommodates at least the upper horizontal beam of the vertical leg support member wherein the vertical wall of the step is connected, via welding or the like, to the front face of the upper horizontal beam and the horizontal floor of the step is connected, via welding or the like, to the top face of the upper horizontal beam. In an embodiment, the step in the outer pivot bracket side plate accommodates the upper horizontal beam and part of the upper portion of the vertical support leg member such that the horizontal floor of the step is connected, via welding or the like, to the top face of the upper horizontal beam and the vertical wall of the step is connected, via welding or the like, to the front face of the upper horizontal beam and the front face of the upper portion of the vertical support leg member. In an embodiment, the step in the inner pivot bracket side plate accommodates the upper horizontal beam and the additional horizontal support member such that the horizontal floor of the step is connected, via welding or the like, to the top face of the upper horizontal beam and the vertical wall of the step is connected, via welding or the like, to the front face of the additional horizontal support member.

In an embodiment, a pivot pin bore for receiving the pivot pin 40 is formed in the pivot bracket side plate in the upper portion. The pivot pin bore of the pivot bracket side plate aligns with the pivot pin bores in the outer supporting rib and the pivot pin is received through this aligned bores to pivotally connect the frame assembly to the mounting assembly. In an embodiment, the pivot pin is a clevis pin.

In an embodiment, a release shaft bore for receiving the release shaft 58, as will be discussed in further detail below, is formed in the pivot bracket side plate in the lower portion. In an embodiment, the pivot bracket side plate is a flat plate member. In an embodiment, the pivot bracket side plate is a flat metal plate member, for example, but not limited to, ¼ inch flat steel plate.

In an embodiment, the trailer-mountable support assembly comprises a locking assembly for releasably locking the frame assembly in the deployed vertically operable and supporting position.

In an embodiment, the locking assembly for releasably locking the frame assembly in the deployed vertically operable and supporting position comprises one or more latch assemblies.

In an embodiment, the locking assembly for releasably locking the frame assembly in the deployed vertically operable and supporting position comprises two horizontally spaced apart latch assemblies, a left latch assembly located at the left side of the trailer-mountable support assembly and a right latch assembly located at the left side of the trailer-mountable support assembly.

In an embodiment, each latch assembly is identical.

In an embodiment, the latch assembly comprises a catch 60, a catch bar 38 and a catch support bracket 62.

In an embodiment, the catch support bracket comprises a pair of horizontally spaced-apart catch support bracket side plates, an outer catch support bracket side plate forming the outer face of the catch support bracket and an inner catch support bracket side plate forming the inner side of the catch support bracket.

In an embodiment, each catch support bracket side plate is identical having an outer surface, an inner surface, a top edge, a bottom edge, a front edge and a rear edge and comprising an upper portion and a lower portion. The upper portion comprises an aperture therethrough for accommodating the release shaft. The rear edge of the upper portion is recessed back from the rear edge of the lower portion creating a step in the rear of the catch support bracket side pate, wherein the step has a vertical wall and a horizontal floor. The step accommodates the upper horizontal beam of the vertical leg support member wherein the vertical wall of the step is connected, via welding or the like, to the front face of the upper horizontal beam and the horizontal floor of the step is connected, via welding or the like, to the bottom face of the upper horizontal beam.

In an embodiment, the horizontally spaced-apart catch support bracket side plates define a central gap or channel therebetween wherein within the lower portion of horizontally spaced-apart catch support bracket side plates, the vertical centre post is received.

In an embodiment, the catch is in the form of a bracket having two horizontally spaced-apart side plates having an upper and a lower portion each upper portion terminating in a bent finger catch and the lower portion being connected by a front connecting wall.

In an embodiment, the horizontally spaced-apart side plates define a central gap or channel therebetween within the upper portion of which the left and right inner supporting ribs of the mounting assembly, respectively are received and nest and within the lower portion of which, the left and right catch support bracket side plates are received and nest.

In an embodiment, the two horizontally spaced-apart side plates of the catch bracket have release shaft bores formed therein which align with the release shaft bores formed in the catch support bracket side plates.

In an embodiment, the inner supporting ribs form a retaining plate for the latch assembly. As discussed above, the inner supporting ribs have a slot formed therein that receives and retains the catch bar.

In an embodiment, the bent finger catch comprises a slot that engages the catch bar when the trailer-mountable support assembly is locked in the operable supporting position and prevents the frame assembly from pivoting relative to the mounting assembly.

In an embodiment, the latch assembly comprises a release shaft. In an embodiment the release shaft spans the width of the trailer-mountable support assembly extending from the outer surface of the left pivot bracket through the aligned release shaft apertures of the left pivot bracket, through the aligned release shaft apertures of the left latch assembly, through the aligned release shaft apertures of the right latch assembly, and through the aligned release shaft apertures of the right pivot bracket through to the outer surface of the right pivot bracket.

In an embodiment, the release shaft is metal bar with a substantially square cross-section. However, the release shaft may take any form or configuration and have any shaped cross-section.

In an embodiment, a manual release handle 64 is connected at one end thereof to the end of the release shaft where it protrudes from the outer surface of the pivot bracket and engages at its other end, for example by clamping, with the vertical support leg member when the locking assembly is in the locked position.

In an embodiment, to release the frame assembly from being locked in the operable vertical position, the operator manually pulls the manual release handle backwards in a direction towards the rear of the trailer which disengages the manual release handle from the vertical support leg member, which in turn, rotates the release shaft, which in turn rotates the bent finger catch which disengages from the catch bar and allows the frame assembly to pivot relative to the mounting assembly and swing backwards to the inoperable raised position.

In an embodiment, the trailer-mountable support assembly comprises a locking assembly for releasably locking the frame assembly in the raised stored position.

In an embodiment, the locking assembly for releasably locking the frame assembly in the raised stored position comprises a lock plate 66 mounted on the mounting assembly and a locking member 68 mounted on the frame assembly for engaging the lock plate when the frame assembly is pivoted and raised toward the underside of the trailer.

In an embodiment, the lock plate is in the form of an elongated key hole lock plate hanging down off the rear side of the mounting assembly and the locking member is in the form of shoulder screw having a head and a shaft protruding out of the outer surface of the vertical support leg member. When the operator pivots the frame assembly relative to the mounting assembly and raises/swings the frame assembly up towards the underside of the trailer, the head of the shoulder screw may be inserted through the head opening of the key hole aperture in the locking plate and then secured within the smaller tail opening of the key hole aperture to lock the frame assembly in the raised stored position.

When the frame assembly is in its raised and locked stored position, and the trailer is still connected with a prime mover or auxiliary mover, the user or operator releases the lock on the frame assembly from the lock plate on the mounting assembly and lowers or swings the frame assembly downwards toward the vertical (manually by gripping the handle or just via gravity), and then pushes the manual release handle forward until it engages with the vertical leg support member which in turn rotates the release shaft rearward, which in turn pivots the catch brackets upward engaging the catch fingers with the catch bars and thus engaging the locking assembly locking the frame assembly relative to the mounting assembly in the vertical operable position. In an embodiment, when the frame assembly is locked in its vertical operable position, the rear face of the frame assembly may be from about 44 inches to about 50 inches, about 44 inches to about 46 inches, about 46 inches to about 48 inches, or about 48 inches to about 50 inches, in front of the landing gear.

When the frame assembly is in its lowered and locked operable position, and the trailer is connected with a prime mover or auxiliary mover, the user or operator pulls the manual release hand rearward releasing the manual release handle from the vertical leg support member which in turn rotates the release shaft forward, which in turn pivots the catch brackets downward releasing the catch fingers from the catch bars and thus disengaging the locking assembly allowing the user or operator to pivot the frame assembly about the pivot brackets moving the frame relative to the mounting assembly by grabbing the handle and swinging or raising the frame assembly back towards the underside of the trailer until the lock on the vertical leg support member can engage and lock into the lock plate on the mounting assembly thereby locking the frame assembly in the raised or stored position.

Although as described above, the trailer-mountable support assembly may be operated manually in a manual mode, it may also be operated automatically in a power-assist mode, as would readily be understood by persons skilled in this art.

Referring to FIG. ?, the trailer-mountable support assembly of the present invention is shown mounted to the underside surface of a trailer immediately forward of the landing gear, more particularly immediately forward of the front gusset of the landing gear, with the trailer pivotally connected to the rear end of a tractor (truck) via the kingpin. The trailer-mountable support assembly is shown in the folded or stored position with the frame assembly raised towards the horizontal where the frame assembly does not create an obstruction in the form of portions thereof disposed a significant distance below the underside of the trailer to the extent that the frame assembly would interfere with the rear end of the tractor and/or with transport of the tractor-trailer combination. Although the landing gear are shown in the extended position, if the landing gear were shown in the retracted position, in such a position, the tractor (truck) may transport the trailer to its destination. Upon reaching the destination and parking the trailer, the landing gear legs are cranked down to their extended position and the frame assembly of the trailer-mountable support assembly is lowered to its operable supporting position, such that the trailer may be detached from the tractor with the forward portion of the trailer resting freestanding upon the landing gear.

The trailer-mountable support assembly of the present invention is a complete stand-alone unit that may be mounted to the underside of any kind of new semi-trailer or retrofittedly mounted to the underside of any kind of existing semi-trailer.

Each of the various components of the trailer-mountable support assembly of the present invention may be constructed of metal, for example steel, aluminum or the like, having the appropriate strength, rigidity and weight characteristics as required and each of the various parts may be fastened together by welding, bolting, screwing, keying and the like, or a combination thereof.

Unless otherwise explained, all technical terms used herein have the same meaning as commonly understood by one of ordinary skill in the art to which this disclosure belongs.

Although any methods and materials similar or equivalent to those described herein can be used in the practice for testing of the present invention, the typical materials and methods are described herein. In describing and claiming the present invention, the following terminology will be used.

It is also to be understood that the terminology used herein is for the purpose of describing particular aspects only and is not intended to be limiting. Patent applications, patents, and publications are cited herein to assist in understanding the aspects described. All such references cited herein are incorporated herein by reference in their entirety and for all purposes to the same extent as if each individual publication or patent or patent application was specifically and individually indicated to be incorporated by reference in its entirety for all purposes. To the extent publications and patents or patent applications incorporated by reference contradict the disclosure contained in the specification, the specification is intended to supersede and/or take precedence over any such contradictory material.

In understanding the scope of the present application, the articles “a”, “an”, “the”, and “said” are intended to mean that there are one or more of the elements. Additionally, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives.

It will be understood that any aspects described as “comprising” certain components may also “consist of” or “consist essentially of,” wherein “consisting of” has a closed-ended or restrictive meaning and “consisting essentially of” means including the components specified but excluding other components except for materials present as impurities, unavoidable materials present as a result of processes used to provide the components, and components added for a purpose other than achieving the technical effect of the invention.

It will be understood that any component defined herein as being included may be explicitly excluded from the claimed invention by way of proviso or negative limitation.

In addition, all ranges given herein include the end of the ranges and also any intermediate range points, whether explicitly stated or not.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

The abbreviation, “e.g.” is derived from the Latin exempli gratia, and is used herein to indicate a non-limiting example. Thus, the abbreviation “e.g.” is synonymous with the term “for example.” The word “or” is intended to include “and” unless the context clearly indicates otherwise.

1. A trailer-mountable retractable support assembly for supporting a freestanding trailer having a landing gear, the support assembly comprising: a mounting assembly for mounting the support assembly to the underside of a trailer and a frame assembly moveably connected to the mounting assembly, wherein the frame assembly is moveable between a stored position wherein the frame assembly is retracted away from the vertical towards the underside of the trailer and a supporting position wherein the frame assembly is substantially vertical and is capable of supporting and stabilizing the trailer on a ground surface when the landing gear fails.

2. The support assembly of claim 1, wherein the frame assembly is pivotally connected to the mounting assembly.

3. The support assembly of claim 1, wherein the frame assembly comprises two vertical supporting leg members.

4. The support assembly of claim 3, wherein the frame assembly comprises two pivot brackets, each pivot bracket associated with a vertical supporting leg member.

5. The support assembly of claim 1, wherein the support assembly comprises a locking assembly for locking the frame assembly in the supporting position.

6. The support assembly of the claim 1, wherein the support assembly comprises a locking assembly for locking the frame assembly in the stored position.
